(19) United States
(12) Patent Application Publication
(10) Pub. No.: US 2009/0080195 A1
(43) Pub. Date: Mar. 26, 2009

(54) WATERPROOF LIGHT

(76) Inventor: Kuo-Hao Huang, Taipei (TW)

Correspondence Address: Rabin & Berdo, P.C., Suite 500, 1101 14th Street, Washington, DC, 20005, US

(21) Appl. No.: 11/861,473

(22) Filed: Sep. 26, 2007

(51) Int. Cl. F21V 31/00

(52) U.S. Cl. 362/267

(57) ABSTRACT

A waterproof light has a socket, a lens, an LED connecting to two wires mounted in the lens, and may further have a partition mounted in the lens. The socket is formed by two casings corresponding and being mounted together to hold the lens. Each casing has a lens recess and two wire grooves, wherein a protruding grip is formed in one of the grooves and multiple ribs are formed in the wire grooves and on the protruding grip. The protruding grips hold and bend the wires in the socket to prevent the wire from being pulled out. The ribs of the two casings prevent water from entering the socket.

### BACKGROUND OF THE INVENTION

1. Field of the Invention

The present invention relates to a decorative light, and more particularly to a decorative light that is waterproof and suitable for mass production.

2. Description of Related Art

A conventional LED-based decorative light may comprise a socket, a color lens mounted on the socket, and an LED light mounted inside the color lens. When manufacturing the decorative light, the LED light is electrically connected to wires first and then placed in a mold for making the socket. Since the socket is fabricated by injection molding the socket can be tightly assembled with the color lens therefore, preventing water from penetrating the decorative light. However, water may enter the decorative light by seeping along the wire and allowing galvanic rusting to occur between the LED light and the wires. This may be avoided by using more expensive wiring, but is costly.

Scale of production of the decorative lights is limited by a quantity of manufacturing equipment. Therefore, mass production of the decorative light requires a large investment in equipment and molding, which results in a high cost.

Another problem of the conventional decorative light is rejection rates during manufacture of light strings. Because all components of the decorative lights are formed in the injection molding process, any defective decorative light must be cut from a light string and replaced with a new one or the entire light string must be rejected. However, replacement of the defective decorative light is a complex process, wastes original components and reduces a final appearance of the decorative light string, yet determining a whole light string to be defective is even more wasteful.

Furthermore, the conventional light string is easily damaged or broken during transportation and in use since the wires may be pulled out of, and separate from the LED, especially during trimming or removal from storage, causing that light to be defective and possibly preventing the whole string from functioning.

To overcome the foregoing shortcomings, the present invention provides a waterproof light to mitigate or obviate the aforementioned problems.

### SUMMARY OF THE INVENTION

The objective of the invention is to provide a waterproof light being suitable for mass production and being waterproof to avoid damages resulting from environment factors.

To achieve the objective, the waterproof light comprises a hollow socket, a lens, an LED connecting to two wires and being mounted in the lens, and may further have a partition mounted in the lens. The socket holds the lens is formed by joining two casings and each casing has a lens recess and two wire grooves, wherein a protruding grip is integrally formed in one of the grooves and multiple ribs are formed in the wire grooves and the protruding grip. The protruding grips hold and bend the wires in the socket to prevent the wire from being pulled out. The ribs in the two casings prevent water from entering the socket.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a waterproof light in accordance with the present invention;

FIG. 2 is a partial cross sectional view of the water proof light of FIG. 1; and

FIG. 3 is a perspective view of the water proof light of the present invention.

### DETAILED DESCRIPTION OF PREFERRED EMBODIMENT

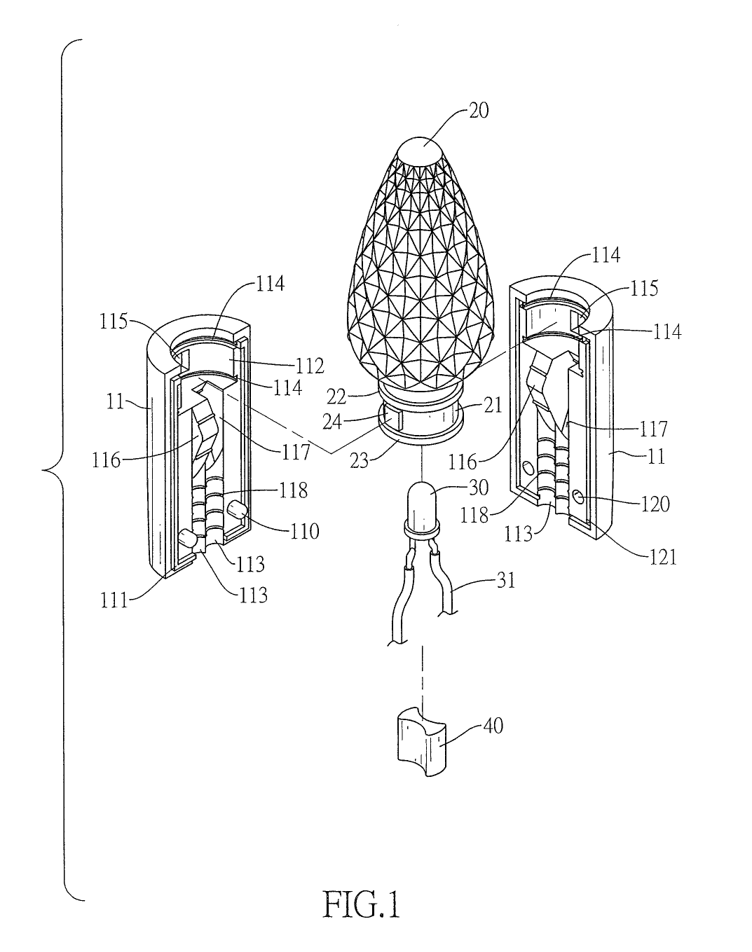

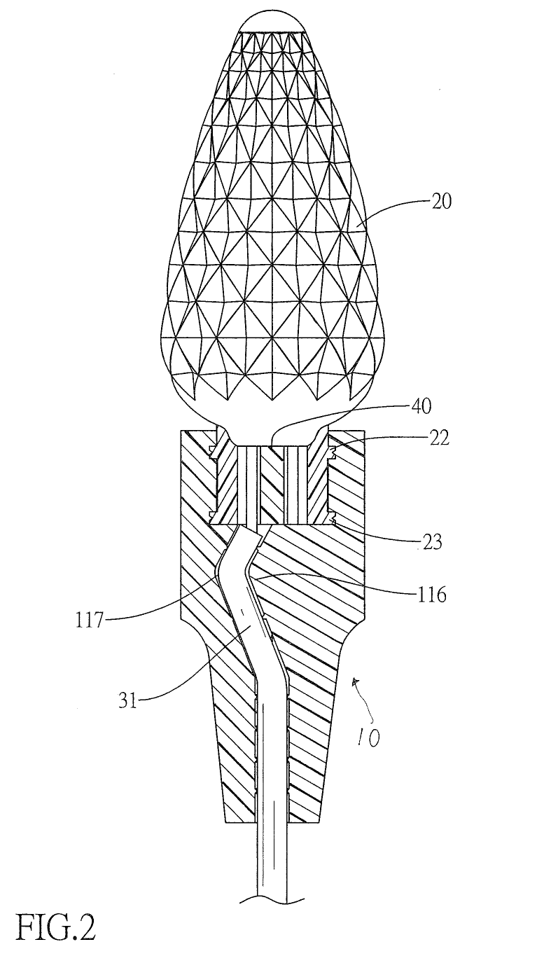

With reference to FIGS. 1, 2 and 3, a waterproof light of the present invention comprise a hollow socket (10), a lens (20), an LED (30) and may have a partition (40).

The socket (10) comprises two casings (11) each having a lens end, a wire end, an engaging surface, may be semi-cylindrical and comprises a lens recess (112) and two wire grooves (113). The engaging surfaces of the casings (11) corresponds to and are mounted flush with each another. One casing (11) may further have engaging stubs (110) and engaging flanges (111) formed on and protruding from the engaging surface, corresponding to and engaging holes (120) and an engaging groove (121) formed in the engaging surface of the other casing (11).

The lens recess (112) is defined transversely in the engaging surface of each casing near the lens end of the casing (11). Each lens recess (112) may have two mounting grooves (114) and a positioning recess (115). The mounting grooves (114) are formed bordering the lens recess (112) and recede deeper into the casing (11). Each positioning recesses (115) is formed on the lens recess (112) between the two mounting grooves (114).

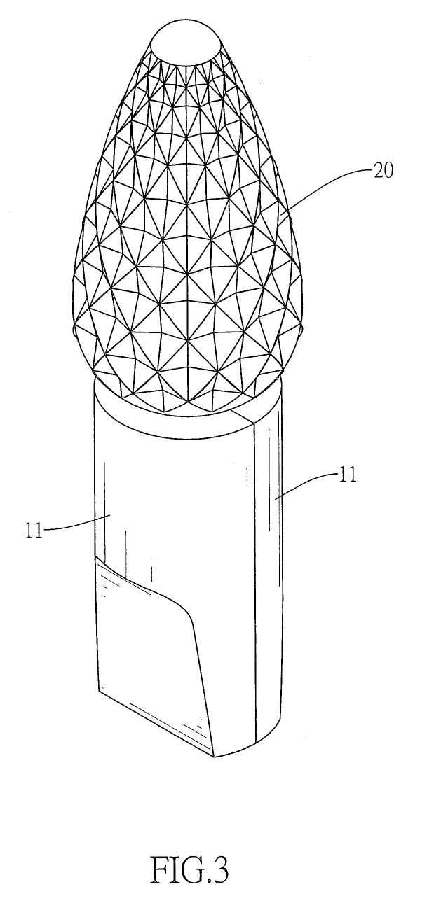

With further reference to FIG. 3, the two wire grooves (113) are parallelly defined longitudinally in the engaging surface, through the wire end of each casing (11), communicate with the lens recess (112), have an inner surface, multiple grip ribs (118), a protruding grip (116) and an recessed grip (117).

The protruding grip (116) is formed from and protrudes from the inner surface of one wire groove (113) of each casing (11) and may be adjacent to the lens recess (112). The recessed grip (117) is formed in and recedes into the other wire groove (113) of each casing (11) corresponding to the protruding grip (116) of the other casing (11).

The protruding grip (116) and recessed grip (117) of one casing (11) complement the recessed grip (117) and the protruding grip (116) of the other casing (11) respectively to form narrow substantial S-shaped gaps.

The grip ribs (118) are formed on and protrude from the protruding grip (116) and the inner surface of each wire groove (113) and the indentation (117).

The lens (20) may be transparent or translucent, and defines an opening with a rim and an inner chamber communicating with the opening. The lens (20) has a neck (21), an upper ring (22), a lower ring (23) and two positioning blocks (24).

The neck (21) is formed from and protrudes from the rim of the opening and is mounted in the lens recesses (112) of assembled casings (11). The upper ring (22) and the lower ring (23) are formed on and protrude around the neck (21) corresponding to and are mounted respectively in the mounting grooves (114) of the assembled casings (11). The two positioning blocks (24) are diametrically formed from and protrude from the neck (21) between the upper ring (22) and the lower ring (23) and are respectively mounted in the positioning recesses (115) of the assembled casings (11) to prevent rotation of the lens (20) in the socket (10).

The LED (30) is connected to two wires (31) and is mounted in the lens (20). The two wires (31) are respectively mounted securely in the wire grooves (113) between the assembled casings (11) and are held securely by the grip ribs (118). The two wires (31) are further held by the S-shaped narrow gaps defined between the protruding grips (116) and the inner surface of the wire channels (113) or the recessed grips (117), so that the wires (31) have a resisting force against an external pulling force. This prevents water from flowing through the wire channels (113) and galvanization of the wire (31) and LED (30) interface from occurring. The partition (40) is mounted in the neck (21) of the lens (20) to separate and insulate the two wires (31) from each other and prevent short circuiting.

Once assembly is complete, the waterproof light is then ultrasonically bonded to obtain a sealed environment.

With the foregoing structure, the assembled waterproof light in accordance with the present invention has the following features.

1. The socket (10) is formed by joining two separate casings (11) using the ultrasonic bonding process, instead of injection molding. Therefore, the present invention is very favorable for mass production.

2. Since the socket is held together before sonic bonding, the entire string may electrically tested for defects, and if defects are found they may be replaced quickly and efficiently.

3. Since the grip ribs (118) tightly press the wires (31) and the upper ring (22) and the lower ring (24) are engaged in the mounting grooves (114), the ribs and the rings prevent water from permeating the socket (10).

4. Since the wires (31) are bent by the protruding grip (116) and held securely by the protruding grip (116) and the recessed grip (117) in the S-shaped gaps, pulling the LED (30) or the wires (31) out of the socket (10) is very difficult, therefore the present invention is more robust and longer lasting.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A waterproof light comprising:
a socket formed by two casings, each casing comprising
a lens end;
a wire end;
an engaging surface corresponding to and mounted flush with the other engaging surface;
a lens recess being defined transversely in the engaging surface near the lens end of the casing; and
two wire grooves being parallelly defined longitudinally in the engaging surface through the wire end of the casing, communicating with the lens recess and each having
an inner surface;
a protruding grip being formed from and protruding from the inner surface of one wire groove; and
a recessed grip being formed in and recedes into the other one of the wire grooves and corresponding to the protruding grip of the other casing to form a S-shaped gap;
multiple grip ribs being formed on and protruding from the inner surfaces of the wire grooves and the protruding grip;
a lens held in the lens recesses between the two casings; and
an LED mounted inside the lens and connecting to two wires that are mounted in the wire grooves, held securely by the protruding grip and grip ribs in the S-shaped gaps and bent by the protruding grip to have a stronger resisting force against an external pulling force thus preventing the wires from being pulled out of the socket.

2. The waterproof light as claimed in claim 1, wherein the lens recess of each casing has
two mounting grooves being formed bordering the recess and receding deeper into the casing; and
a positioning recess formed between the two mounting grooves; and
the lens further comprises
an opening with a rim;
an inner chamber communicating with the opening;
a neck being formed on and protruding from the rim of the opening and being mounted in the lens recesses of the casings;
an upper ring and a lower ring formed around the neck, corresponding to and being mounted respectively in the mounting grooves of the two casings; and
two positioning blocks being diametrically formed from and protruding from the neck between the upper ring and the lower ring and corresponding to and mounted in the positioning recesses of the casings.

3. The waterproof light as claimed in claim 2, wherein multiple grip ribs are formed in the recessed grip of each casing.

4. The waterproof light as claimed in claim 3, wherein a partition is mounted in the neck of the lens, separating and insulating the wires in the lens.

5. The waterproof light as claimed in claim 4, wherein
one of the casings further comprises engaging stubs and an engaging flange being formed on and protruding from the engaging surface; and
the other casing further comprises corresponding engaging holes and an engaging groove being formed on and receding into the engaging surface.

6. The waterproof light as claimed in claim 5, wherein the each casing is semi-cylindrical.

7. The waterproof light as claimed in claim 6, wherein the protruding grip of each casing is adjacent to the lens recess.
